(19) United States
(12) Patent Application Publication
(10) Pub. No.: US 2015/0221240 A1
(43) Pub. Date: Aug. 6, 2015

(54) MULTI-FUNCTION LABELS

(71) Applicant: QUALITY ASSURED ENTERPRISES INC., Hopkins, MN (US)

(72) Inventor: Joseph D. Franko, JR., Hopkins, MN (US)

(21) Appl. No.: 14/414,808

(22) PCT Filed: Jul. 16, 2013
(86) PCT No.: PCT/US13/50643

§ 371 Date: Jan. 14, 2015

Related U.S. Application Data
(60) Provisional application No. 61/672,471, filed on Jul. 17, 2012.

(51) Int. Cl. G09F 3/02; B32B 3/26

(52) U.S. Cl. CPC G09F 3/02; B32B 3/266; G09F 2003/0257; B32B 2250/03; B32B 2519/00; G09F 2003/0255

(57) ABSTRACT

A multi-function label could include a base ply and a top ply. A clear laminate material could be provided on the top ply. At least one bond area could be provided between the base ply and the top ply. At least one cut could be provided through the top ply.

### TECHNICAL FIELD

This disclosure relates generally to labels. More particularly, this disclosure relates to multi-function label webs, and individual labels created therefrom, that are suitable for use with existing roll-fed label application equipment, for provision of booklet label and/or removable coupon features.

### BACKGROUND

In the printing arts, and in particular in the printed label art for labeling and decorating objects, a label construction type that has gained wide popularity is a so-called “roll-fed” label. A roll-fed label commonly utilizes a continuous label substrate or base ply comprising paper, or a clear or opaque film such as polypropylene, or a combination of paper and film. In such an individual label, in its final state, the base ply is, usually, substantially rectangular, as defined by a desired label width associated with a widthwise dimension and a desired label length associated with a lengthwise dimension (transverse to the widthwise dimension). The base ply has opposing first and second ends, along with front and back surfaces. Desired graphics are typically printed on the front surface of the base ply, and may also be printed on the back surface. In application of the roll-fed label to an object to be labeled, e.g., a cylindrical container, a widthwise portion of the back surface of the base ply at the first end thereof is adhered to the container by means of an adhesive material at point of application from labeling equipment. The base ply, having been adhesively secured to the container at the first end, is then placed in circular fashion around the container and adhesively secured at the second end of the base ply adjacent to the first end. The length of the base ply is usually chosen to approximate a circumference of the container, to minimize excessive overlap of the opposing ends of the label substrate applied to the container. The application of the label to the container may be carried out by any suitable roll-fed label applicator such as those available from, e.g., Krones A. G. of Regensburg, Germany, and B&H Labeling Systems of Ceres, Calif., U.S.A.

Roll-fed labels of the type described herein are manufactured for application by customers using conventional roll-fed labeling equipment or machines. They are produced without any adhesive material on the back surface of the base ply; and as such they are provided to customers in roll form as a web.

Typically, at point of application, a web of labels in roll form is introduced to a customer's label application machine which cuts the web into individual labels and applies them to objects to be labeled (e.g., containers). Any adhesive material used to apply the labels to the objects is supplied by the label application machine at the point of application and is generally applied to adhere the leading and trailing edge portions of the labels.

Generally in the labeling and decorating arts, there exists a continual demand for labels and decorations which not only appeal to consumers, but also bear ever increasing amounts of information. For example, labels for identification of health care and pharmaceutical products are often required by governmental regulations to describe in painstaking detail their compositions and ingredients. As new food and drug laws are passed, regulations require the inclusion of increasing amounts of label information. As another example, labels for identification of industrial, agricultural, and individual consumer-oriented pest and insect control products, such as lubricants, fertilizers, and insecticides, are similarly required by governmental regulations to describe their compositions and ingredients by way of, e.g., “material safety data sheets” and the like. Also, labeling for such products commonly includes instructions for their proper use and disposal, along with instructions for first aid upon accidental exposure to the products.

Traditional extended text, expanded content, or booklet type labels (collectively, “booklet type labels”), however, are usually not capable of being successfully utilized with typical roll-fed label application equipment.

Also in the labeling and packaging arts, various forms of so-called “coupon” labels have provided features of traditional coupons to consumers of labeled products, such as would be clipped out of a newspaper or a printed advertising publication for promotion of brand loyalty through cost savings to the consumers provided by such elements. The term “coupon” has also referred to so-called “instantly redeemable coupons” or “IRCs” which may be carried on an underlying primary label or pre-decorated package, and may be separable therefrom without defacing or otherwise damaging either the coupon or the underlying label or package. Thus, a coupon may be essentially characterized as a secondary component that is adhered to a primary label or package as a separate and subsequent labeling process step. As such it will be observed that a coupon is, commonly, both manufactured and applied in separate states and process steps.

Therefore, there exists a need for multi-function labels that do not require modification of existing roll-fed label application equipment, machines, or processes, and do not require significant changes to label ply materials, adhesive materials at point of application, or other labeling components. There also exists a need for multi-function labels that advantageously provide, in roll-fed label constructions, features of both a booklet type label and/or a coupon. There additionally exists a need for multi-function labels in which portions of primary roll-fed labels themselves also function as coupons, which would distinctively and advantageously obviate any need for manufacturing and applying the coupons in separate states and process steps. Furthermore, such constructions would advantageously permit coupon manipulation without destructing or otherwise deleteriously compromising the primary label or package. Accordingly, multi-function labels would satisfactorily function (i) as booklet type labels when applied to containers such as conventional aerosol spray cans, subsequently with caps, even when the caps abut or cover portions of the labels, and/or (ii) as removable coupons.

### SUMMARY

This disclosure describes novel label webs and resulting labels that do not require modification of existing roll-fed label application equipment or machines for application of the labels to objects to be labeled.

In one aspect, a multi-function label web could include a base ply and a top ply. At least one bond area could be provided between the base ply and the top ply. A plurality of cuts could be provided through the top ply.

In another aspect, a multi-function label web could include a base ply and a top ply. At least one bond area could be provided between the base ply and the top ply. A plurality of cuts could be provided through the top ply. The multi-function label web could be characterised in that a multi-function label could be created therefrom, with the multi-function label providing, in a roll-fed label construction, features selected from a group consisting of (i) a booklet type label, (ii) a coupon, and (iii) a combination booklet type and coupon label.

### BRIEF DESCRIPTION OF THE DRAWINGS

FIG. 1 is an illustration of an example of a multi-function label in a finished state, adhered to a container at point-of-sale.

FIG. 2 is a top view illustration of a portion of an example of a label web, for use by a roll-fed label application machine in application of the example of a label to the container in FIG. 1.

FIG. 2a is a cross-sectional illustration of the portion of the example of a label web shown in FIG. 2, taken along line 2a-2a in FIG. 2.

FIG. 3 is a top view illustration of the example of a multi-function label of FIG. 1, after having been cut and separated, at point of application, from the example of a label web of FIG. 2.

FIG. 3a is a top view illustration of another example of a multi-function label, after having been cut and separated from a label web.

FIG. 4 is an illustration of the example of a multi-function label of FIG. 3, after having been applied to a container at point of application and showing its coupon portion initially opened.

FIG. 5 is an illustration of the example of a multi-function label of FIG. 4, showing its coupon portion being separated and removed from the label on the container.

### DETAILED DESCRIPTION

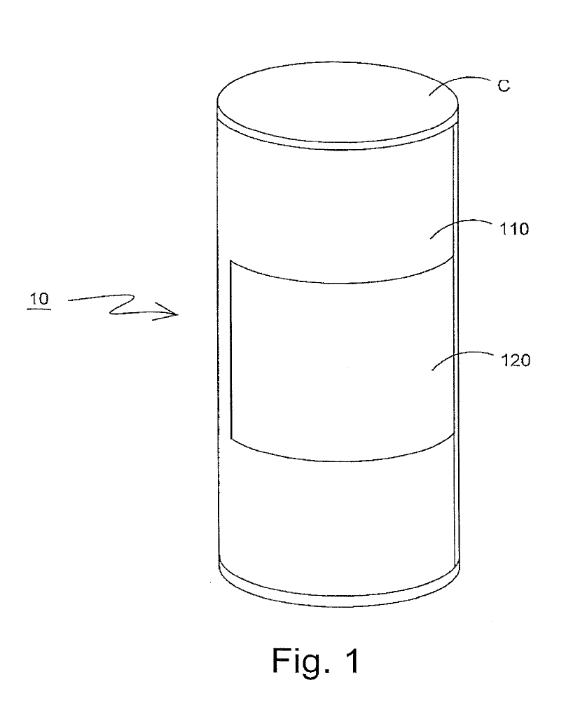

An example of a multi-function label 10, in a finished state and adhered to a container C, shown at point-of-sale, is illustrated in FIG. 1. Multi-function label 10 generally comprises a base ply 100 (not visible), a top ply 110, and a coupon 120 that functions in both booklet-type and/or coupon fashion, as will be further described.

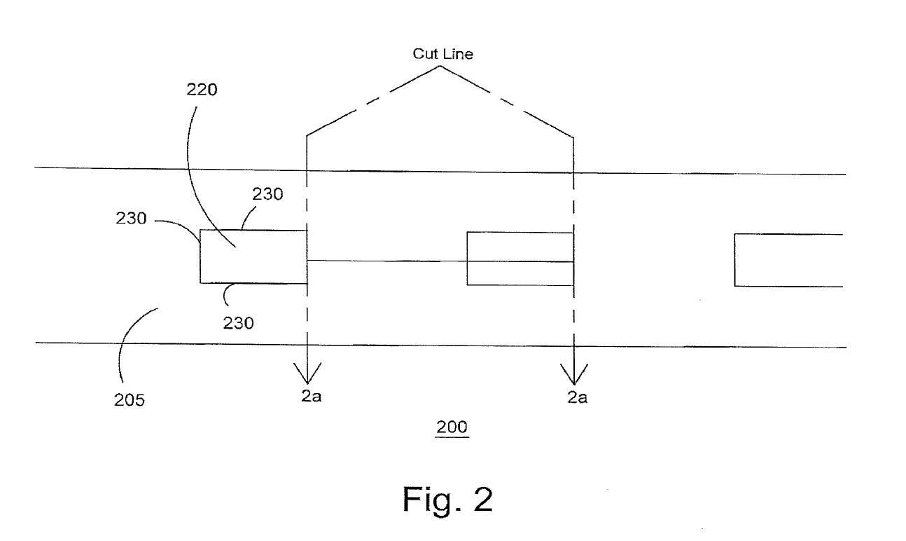

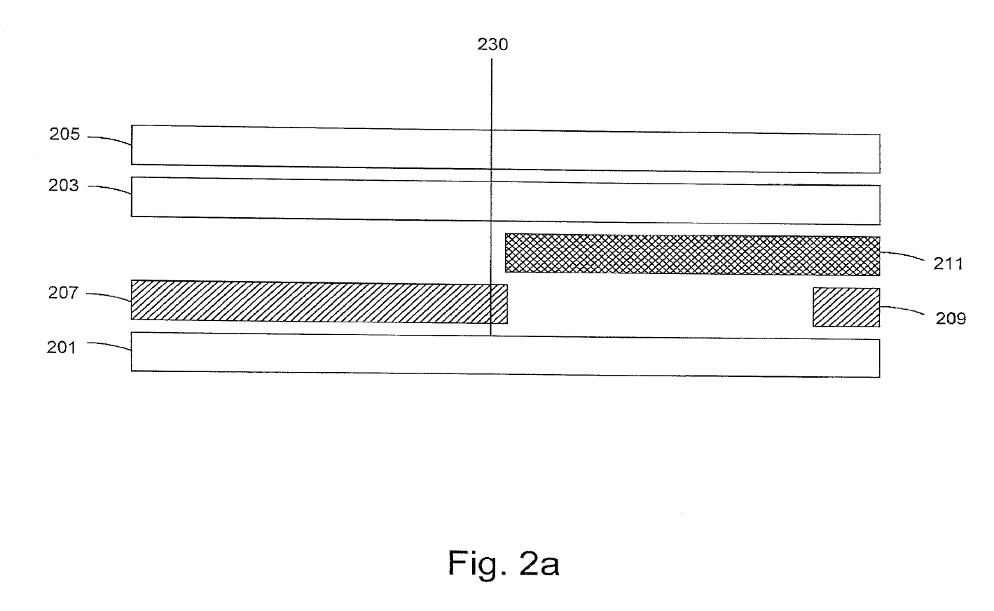

FIGS. 2 and 2a are top view and cross-sectional illustrations, respectively, of a portion of an example of a label web comprising a continuous sequence of multi-function label constructions that will be converted by a label application machine into individual, separate multi-function labels for application to respective individual, separate containers. The label web includes a top ply, a base ply, two separate, repeating bond areas between the plies each comprising a coupling system, an optional release-reseal system, and cut lines representing locations where individual labels will be cut from the overall web at point of application.

As used throughout this disclosure, the term “coupon” refers to a portion of a label that is intended to be (i) manipulated by, typically, a consumer or end-user to access information or graphics and then optionally resealed if desired, and (ii) if desired, entirely removed and separated from the overall label structure in removable coupon fashion.

It is to be noted that a multi-function label, for application to an object to be labeled utilizing separately supplied adhesive material with a roll-fed label application machine, includes a base ply and at least one top ply. The term “top ply”, as used herein, refers to any ply above the base ply in the label structures and of which there may be more than one. The base ply has a first lengthwise dimension, a first widthwise dimension, a front surface that is optionally capable of bearing graphic images and coatings, and an adhesive-free back surface that is also optionally capable of bearing graphic images and coatings and capable of being adhesively coupled to an object to be labeled using separately supplied adhesive material at point of application. The at least one top ply has a second lengthwise dimension, a second widthwise dimension, a front surface that is optionally capable of bearing graphic images and coatings, and a back surface that is also optionally capable of bearing graphic images and coatings. The base ply and the at least one top ply are adhesively coupled, in a first portion of the label, to each other such that the front surface of the base ply and the back surface of the at least one top ply are preferably, but not necessarily, in contiguous juxtaposition with each other along the first lengthwise dimension and the second lengthwise dimension, respectively, and along the first widthwise dimension and the second widthwise dimension, respectively. Also, the base ply and the at least one top ply are preferably, but not necessarily, in a second portion of the label, releasably and resealably coupled to each other. As indicated above, when manufactured and prior to being applied to an object of interest to be labeled, the back surface of the base ply is free of adhesive material. In this state, it can then be supplied as a continuous web in roll form to a conventional roll-fed label application machine.

It is to be understood that any ply in a multi-function label may be a single ply of material, whether coated or uncoated, a so-called clear protective laminate construction, or any laminated, combined ply, or co-extruded construction.

With particular reference again to FIGS. 2 and 2a, illustrated in FIG. 2 is a top view of a portion of an example of a multi-function label web 200, while FIG. 2a illustrates a cross-sectional view of a portion of the example of a multi-function label web 200. Label web 200 includes a base ply 201, a top ply 203, a clear laminate material 205, two separate bond areas represented by adhesive materials 207 and 209, and a release material 211. Cuts 230 are made, as shown in the drawing, downwardly to—but not through—base ply 201.

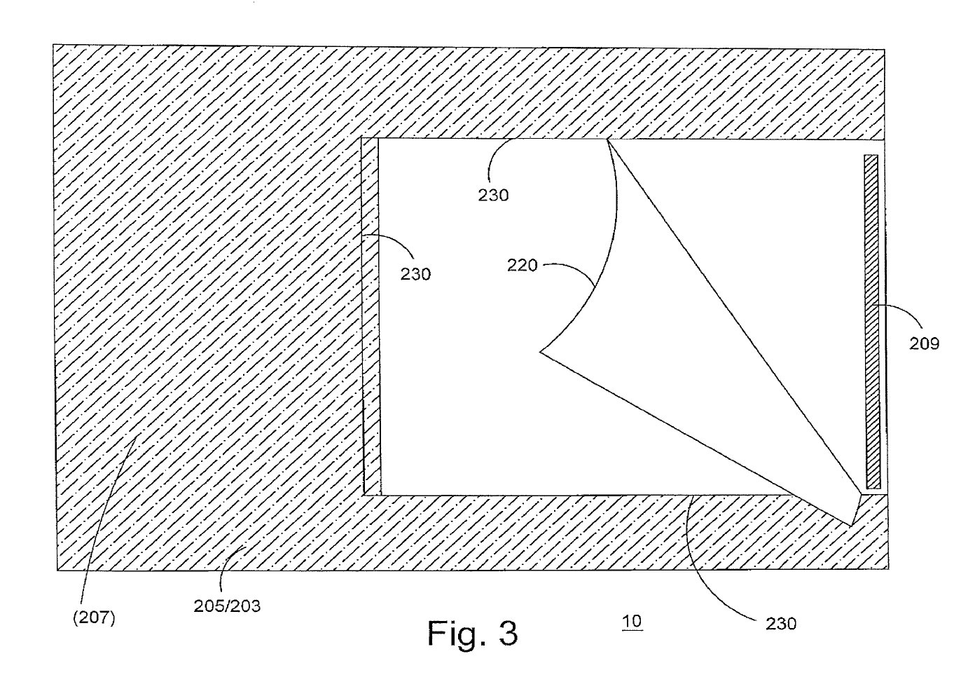

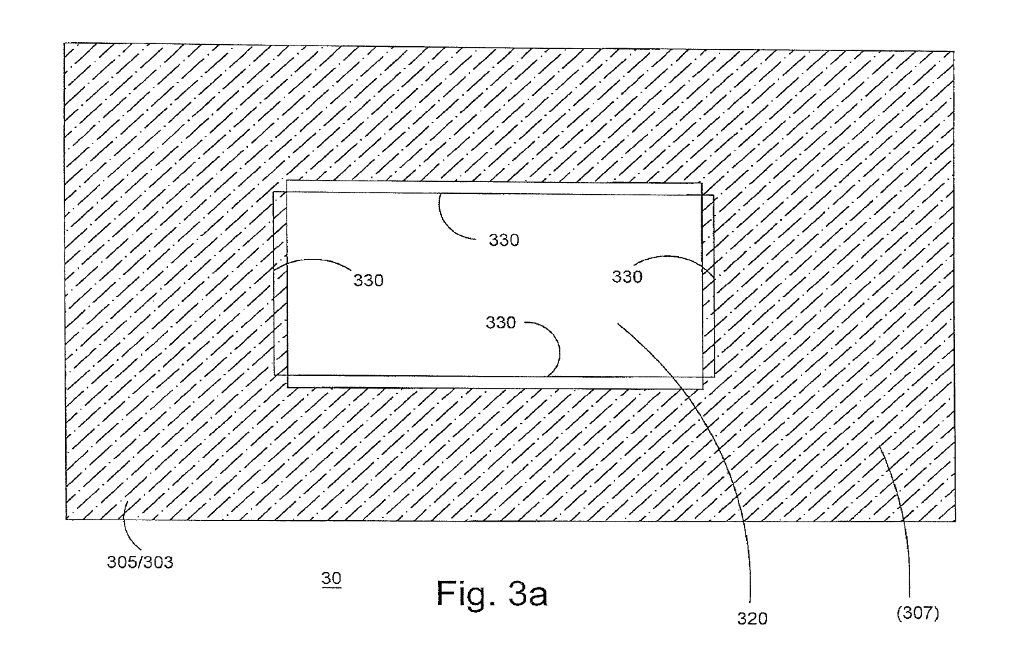

FIG. 3 is a top view illustration of the example of a multi-function label 10, after having been cut and separated, at point of application, from the example of a label web of FIG. 2. Label 10 includes a coupon 220 (shown as being partially opened) and cuts 230 that are made through laminate material 205 and top ply 203 (designated together as 205/203). In the drawing, adhesive material (207) is visible in “phantom” fashion, since it would not otherwise be visible in a top view of label 10.

FIG. 3a is a top view illustration of another example of a multi-function label 30, after having been cut and separated from a label web (not illustrated). Label 30 includes a coupon 320 and cuts 330 that are made through laminate material 305 and top ply 303 (designated together as 305/303). In the drawing, adhesive material (307) is visible in “phantom” fashion, since it would not otherwise be visible in a top view of label 30.

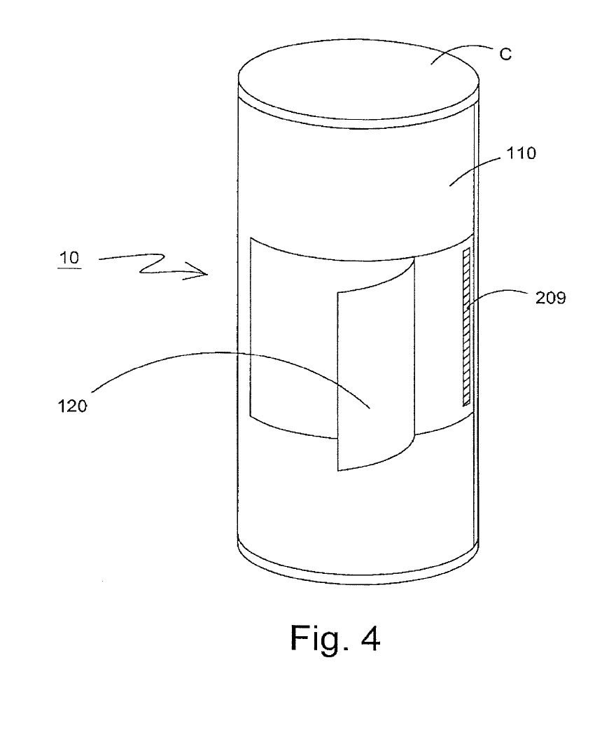

FIG. 4 is an illustration of the example of a multi-function label 10 of FIG. 3, after having been applied to a container C at point of application and showing its coupon 120 as being partially opened. Also visible in FIG. 4 is adhesive material 209, as shown in FIG. 2a.

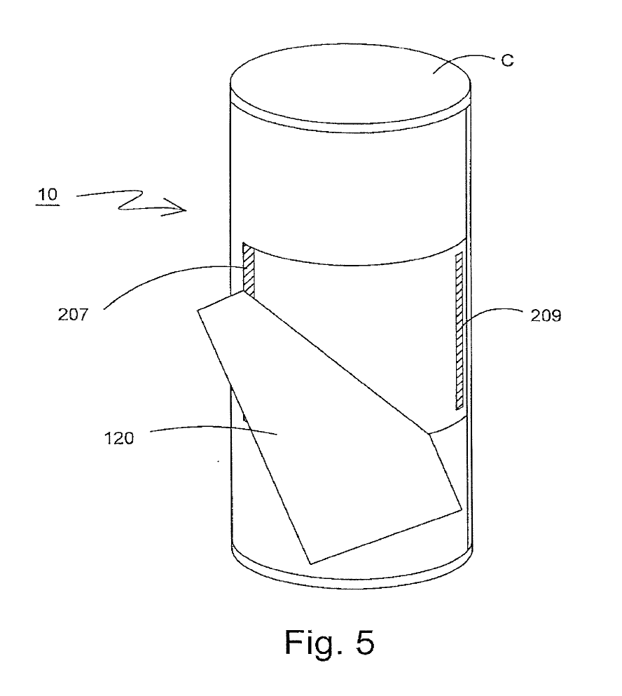

FIG. 5 is an illustration of the example of a multi-function label of FIG. 4, showing its coupon 120 being removed from the label on the container. It is to be appreciated and understood that an action of removal of the coupon from the label—by, e.g., a consumer at point of purchase—may be effected by controlled, purposeful destruction of the plies, or by any means of achieving a removable bond of the coupon from the overall label structure. Preferably, such removal would not obscure or otherwise degrade or compromise any graphics on the plies.

Although not illustrated, it is to be understood that instead of the aforedescribed cuts (e.g., cuts 230 in FIG. 2) such as provided by die-cutting apparatus in a roll-fed label printing and converting press or manufacturing installation, any other suitable converting of the ply material or materials could be utilized—provided that such alternatives at least approximately emulate traditional die cutting of the ply material or materials.

Also, although not illustrated, it is to be understood that the adhesive materials could alternatively be provided on back surfaces of the top plies as well as the front surfaces of the base plies, or both. Similarly, the release materials could alternatively be provided on back surfaces of the top plies as well as the front surfaces of the base plies, or both.

It is also to be understood that a particular embodiment of a multi-function label could intentionally omit release material and instead utilize a ply material that inherently has a release property where the release material would otherwise be present. Furthermore, an adhesive material having a sufficiently low aggressiveness (e.g., a removable or low-tack adhesive material) could be utilized for a multi-function label having a ply material (e.g., paper or film) without an inherent release property or coating. In such an application, the adhesive material of sufficiently low aggressiveness could inhibit destruction of the ply material while still maintaining releasability and resealability of the multi-function portion of the label.

It is to again be appreciated and understood that patterns of adhesive materials and release materials employed to provide various embodiments of a multi-function label may take any desirable form or configuration; and that regardless of a particular pattern of adhesive material or release material, a multi-function label and/or label web may selectively and optionally have defined cut zones where no adhesive material is present or the adhesive material is set back therefrom. However, cut zones defining areas without adhesive materials may be omitted in a particular embodiment when performance of a particular label application machine would not be negatively affected by presence of adhesive materials. Such an application machine could, for example, employ non-mechanical contact cutting by way of a laser.

It is to be appreciated and understood that, although not specifically illustrated, a multi-function label that incorporates a coupon feature could, additionally or alternatively, provide a removable booklet. For example, the coupon could comprise a booklet; and the booklet could also be of a construction that includes one or more material plies in addition to a base ply and top ply. Further, although not specifically illustrated, a multi-function label that incorporates a coupon and/or booklet feature could, additionally or alternatively, provide a material safety data sheet as aforementioned—or any desired function that is otherwise made capable by way of a coupon and/or booklet portion in the label.

It is to be appreciated and understood that in a particular embodiment of a multi-function label, any areas or regions of the label defined by that label's height H, length L, or any combinations of its parameters, could serve as the coupon and/or booklet portion. Additionally, it is to be appreciated and understood that in a particular embodiment of a multi-function label, the label could have a plurality of separate coupon and/or booklet portions effectively serving as a plurality of “windows” for, e.g., accommodation and presentation of multi-lingual information.

Regarding constructions of various embodiments of a multi-function label, the base plies and top plies could preferably be any commercially available web-like materials that are capable of use in an in-line printing and converting process. Such materials could be, for example, polypropylene as is commercially available from AET Films of Terre Haute, Indiana, in the U.S. As used herein, the term “web-like materials” is intended to include any suitable label materials, including paper, film, polypropylene, polyethylene, polyester, polyvinylchloride, polystyrene, foil, and ethylene vinyl acetate. The plies selectively could, individually or collectively, comprise so-called “shrink promoting” materials to conform to several or irregular curvatures of objects to which they are applied. Such materials include, but are not limited to, those that exhibit desired stretch and shrinkage characteristics such as are commercially available and known to those skilled in the art. Also, adhesive materials and release materials that may be utilized in constructions of various embodiments of a multi-function label could preferably be chosen from water-based, solvent-based, UV/EB, cold seal, heat seal, cohesive, and hot melt coatings as are commercially available. The adhesive materials used in constructions of the overall roll-fed label webs, which may be either (i) tacky in a final state (e.g., pressure-sensitive) or (ii) non-tacky in a final state, are preferably chosen to provide bonding between the base plies and the top plies in the labels described herein, while the release coatings are preferably chosen with respect to, and in combination with, the adhesive materials to provide ease of opening and resealability of the labels. Furthermore, it is to be understood that an adhesive material utilized for provision of a coupling element in a particular multi-function label could be, as may be desired in certain circumstances, different than an adhesive material utilized for provision of a release-reseal system in the same label.

Generally, it is to be appreciated and understood that several of those embodiments of a multi-function label described herein could have particular utility in labeling objects or containers that have a regular shape, which may be cylindrical, or another shape, which is of relatively constant circumference from top to bottom. Other objects or containers, however, may have substantially non-constant outer dimensions such as, e.g., coved or rounded top and bottom shoulder-type tapers which, it is to be understood, also could be accommodated by a particular embodiment of a multi-function label. Furthermore, it is to be understood that any embodiment of a multi-function label could be applied by so-called “cut-and-stack” labeling equipment to an object of interest to be labeled.

While this disclosure has been particularly shown and described with reference to accompanying figures, it will be understood, however, that modifications are possible. It should be appreciated that various components described herein may be substituted for other suitable components for achieving desired results, or that various accessories may be added thereto. Further, components such as the ply, adhesive, and release materials, and the cuts, could be provided in any desirable order, configuration, orientation, and form, so long as they function together satisfactorily in a manner of a multi-function label as described by example or otherwise contemplated herein. Also, it is to be appreciated and understood that, with suitable modification or modifications, a selected portion of the base ply could act as a coupon and/or booklet. Thus, it is to be understood that any suitable alternatives may be employed to provide multi-function labels.

Also, the depictions of various containers in the figures are only exemplary and not meant to be limiting.

Lastly, the choice of compositions, sizes, and strengths of various components described herein are to be selected depending upon intended use.

Accordingly, these and other various changes or modifications in form and detail may be made to multi-function labels, without departing from the true spirit and scope thereof.

What is claimed is:

1. A multi-function label web, comprising:
a base ply;
a top ply;
a clear laminate material on said top ply;
a first bond area between said base ply and said top ply;
a second bond area between said base ply and said top ply; and
a plurality of cuts through said laminate material and said top ply.

2. The multi-function label web of claim 1, characterised in that a multi-function label is created therefrom, with said multi-function label providing, in a roll-fed label construction, features selected from a group consisting of (i) a booklet type label, (ii) a coupon, and (iii) a combination booklet type and coupon label.
